(19) United States
(12) Patent Application Publication
(10) Pub. No.: US 2008/0257891 A1
(43) Pub. Date: Oct. 23, 2008

(54) CONTAINER ASSEMBLIES WITH BAG ENGAGING MEMBER

(75) Inventors: Ian D. Kovacevich, Charlotte, NC (US); Daniel Lee Bizzell, Davidson, NC (US); Matthew Blake Wynn, Charlotte, NC (US); Thomas James Philpott, Charlotte, NC (US)

Correspondence Address: TILLMAN WRIGHT, PLLC, P.O. BOX 471581, CHARLOTTE, NC, 28247, US

(73) Assignee: Pressix Technologies, LLC, Charlotte, NC (US)

(21) Appl. No.: 12/108,424

(22) Filed: Apr. 23, 2008

Related U.S. Application Data
(63) Continuation of application No. 12/101,847, filed on Apr. 11, 2008.
Application No. 12/101,847 is a continuation of application No. PCT/US2008/055203, filed on Feb. 27, 2008.
(60) Provisional application No. 60/891,931, filed on Feb. 27, 2007.
(60) Provisional application No. 60/950,647, filed on Jul. 19, 2007.

(51) Int. Cl. B65D 90/00; B23P 11/00

(52) U.S. Cl. 220/495.11; 29/428

(57) ABSTRACT

An assembly includes a container having a top rim defining a mouth of the container and an attachment member that is attached to and extends around the rim of the container. The container defines a side opening into an interior of the container from an exterior of the container. The attachment member includes a bag engaging member located in covering relation to the side opening.

### CROSS-REFERENCE TO RELATED APPLICATION

The present application is a U.S. continuation patent application of, and claims priority under 35 U.S.C. § 120 to, U.S. patent application Ser. No. 12/101,847, filed Apr. 11, 2008, which '847 application is a U.S. continuation patent application of, and claims priority under 35 U.S.C. §120 to, International Patent Application Serial No. PCT/US2008/055203, designating the United States and filed on Feb. 27, 2008, which International Patent Application is a nonprovisional patent application of, and claims priority under 35 U.S.C. §119(e) to, each of U.S. provisional patent application Ser. No. 60/891,931, filed Feb. 27, 2007, and U.S. provisional patent application Ser. No. 60/950,647, filed Jul. 19, 2007. These patent applications, and any corresponding patent application publications, are incorporated by reference herein.

The present application furthermore incorporates by reference each of the following: U.S. patent application Ser. No. 11/424,920, now U.S. Pat. No. 7,243,811; U.S. patent application Ser. No. 11/424,968, and corresponding U.S. Patent Application Publication No. 2007/0034334 A1; U.S. patent application Ser. No. 11/424,969, and corresponding U.S. Patent Application Publication No. 2007/0289972 A1; U.S. patent application Ser. No. 11/778,839, and corresponding U.S. patent Application Publication No. 2008/0011910 A1; U.S. patent application Ser. No. 11/778,841, and corresponding U.S. Patent Application Publication No. 2008/0011754 A1; U.S. Design patent application Ser. No. 29/296,856; U.S. Design patent application Ser. No. 29/296,859; and U.S. Design patent application Ser. No. 29/296,860.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to a trashcan assembly having bag engaging members for grasping and retaining a trash bag.

The use of trashcan devices is known in the prior art. U.S. Pat. No. 6,126,031, which is incorporated herein by reference, describes a device having a bottom compartment for holding a roll of trash bags so that the trash bags may be retrieved as needed through an opening extending into the bottom compartment. Another type of trashcan device is disclosed in U.S. Pat. No. 5,636,416, which is incorporated herein by reference, which device has a conventional shape and which includes clips that are attachable to a trash bag. The clips are positioned outside of the trashcan to prevent the trash bag from falling back into the trashcan. Another clip assembly for securing a trash bag is found in U.S. Pat. No. 5,645,186, which is incorporated herein by reference.

While these devices fulfill their respective, particular objectives and requirements, it is believed that a need remains for a simple trashcan assembly that allows a trashcan liner—sometimes referred to herein as a trash bag and vice versa—to be secured directly to the trashcan assembly in order to prevent the trash bag from slipping and falling into the trashcan assembly.

### SUMMARY OF THE INVENTION

The present invention includes many aspects and features. Moreover, while many aspects and features relate to, and are described in, the context of trashcan assemblies, the present invention is not limited to use only in trashcan assemblies, and can be used in other context in which an assembly includes a container and a pliable liner or bag received therein.

In an aspect of the invention, a container assembly includes a container having a peripheral wall forming an interior space for receipt of a pliable liner therein. The peripheral wall surrounds and defines an opening therein. An insert is received within the opening and secured to the peripheral wall. The insert includes a liner engaging member defining a passageway into the interior space of the container. The liner engaging member includes a plurality of resilient, flexible fingers configured to receive and retain a portion of a pliable liner that is extended through the passageway.

In a first feature of this aspect, each finger includes a portion thereof that extends away from the peripheral wall on the exterior of the container and a portion thereof that extends toward the interior space of the container.

In a second feature of this aspect, the insert includes a circumferentially extending channel within which a portion of the peripheral wall of the container is received, whereby the insert is secured to the peripheral wall.

In a third feature of this aspect, the insert is injection molded.

In a fourth feature of this aspect, the liner engaging member includes an arrangement of slots that extend away from a center of the arrangement and that define the plurality of fingers between adjacent ones of the slots. In at least one embodiment of this fourth feature, the slots define at least four fingers. In at least one other embodiment of this fourth feature, the fingers do not include pointed ends all converging toward a common point. Additionally, in at least one embodiment in which the fingers do not include pointed ends all converging towards a common point, the ends of the fingers point generally towards the interior space of the container. Further, in at least one embodiment in which the ends of the fingers point generally towards the interior space of the container, the fingers define a central opening of the liner retention member.

In a fifth feature of this aspect, a portion of a liner extends from the interior of the container over a rim of the container and through the liner engaging member and is disposed in frictional engagement with the fingers such that the liner is secured from slipping into the container when trash is received within the liner in the container. In at least one embodiment of this fifth feature, only a portion of the liner extends through the liner engaging member in order to prevent the liner from slipping into the container.

In another aspect of the invention, a method of making a assembly includes the steps of (a) providing a container having a peripheral wall defining an interior space for receipt of a trash bag therein; (b) providing an insert having a bag retention member including a plurality of resilient, flexible fingers configured to receive and retain a portion of a trash bag that is extended therethrough; (c) forming an opening in the peripheral wall of the container; and (d) securing an insert within the opening to the peripheral wall.

In a first feature of this aspect, step (d) includes seating the insert in the opening, wherein a portion of the sidewall of the container is received within a channel of the insert. In at least one embodiment of this first feature, the channel fully encircles a circumferential periphery of the insert. In at least one embodiment of this first feature, the insert is secured to the peripheral wall via a snap-fit mounting. In at least one embodiment of this first feature, the insert includes a flange that serves as a skirt to cover the periphery of the opening formed in the container.

In a second feature of this aspect, each finger includes a bent finger with the end thereof pointing toward the interior space of the container.

In another aspect of the invention, a method of retrofitting a container having a peripheral wall defining an interior space for receipt of a trash bag therein includes the steps of forming an opening in the peripheral wall of the container; and securing an insert within the opening to the peripheral wall, the insert having a bag retention member including a plurality of resilient, flexible fingers configured to receive and retain a portion of a trash bag that is extended therethrough.

In a first feature of this aspect, step (a) includes cutting an opening in the peripheral wall.

In a second feature of this aspect, step (a) includes punching an opening in the peripheral wall.

In another aspect of the invention, a container assembly includes a container and an attachment member that is received on the rim of the container and that includes bag engaging members.

In a first feature of this aspect, the attachment member resembles a band. In at least one embodiment of this first feature, the attachment member has an inner diameter of about fourteen inches. In at least one embodiment, the attachment member includes an annular recess within which the rim of the container is received. The rim may be received in a snap-fit connection with the attachment member, or may be adhered or otherwise bonded to the attachment member for permanent attachment therebetween.

In a second feature of this aspect, the attachment member may be injection molded from one or more materials. In at least one embodiment of this second feature, the materials include one or more thermoplastic materials and one or more elastomers. In at least one embodiment of this second feature, the attachment member is entirely made from the same material in an injection molding process, and each bag engaging member is formed by simply forming openings in the attachment member, either during the injection molding process or thereafter. In at least one other embodiment of this feature, the attachment member is formed from two portions that are co-molded together.

In another aspect of the invention, a container assembly includes an outer container and an interior container that both is removably received within the container and includes one or more bag engaging members.

More aspects and features are set forth below in the context of a trashcan assembly.

In this respect, another aspect of the invention relates to a trashcan assembly that includes a container having a peripheral wall forming an interior space for receipt of a pliable liner therein. The peripheral wall surrounds and defines an opening therein. An insert is received within the opening and secured to the peripheral wall. The insert includes a liner engaging member defining a passageway into the interior space of the container. The liner engaging member includes a plurality of resilient, flexible fingers configured to receive and retain a portion of a pliable liner that is extended through the passageway.

In a first feature of this first aspect, each finger includes a portion thereof that extends away from the peripheral wall on the exterior of the container and a portion thereof that extends toward the interior space of the container.

In a second feature of this first aspect, the insert includes a circumferentially extending channel within which a portion of the peripheral wall of the container is received, whereby the insert is secured to the peripheral wall.

In a third feature of this first aspect, the insert is injection molded.

In a fourth feature of this first aspect, the liner engaging member includes an arrangement of slots that extend away from a center of the arrangement and that define the plurality of fingers between adjacent ones of the slots.

In at least one embodiment of this fourth feature, the slots define at least four fingers.

In at least one other embodiment of this fourth feature, and possibly concurrent with the previous enumerated embodiment, the fingers do not include pointed ends all converging toward a common point. Additionally, in at least one embodiment in which the fingers do not include pointed ends all converging towards a common point, the ends of the fingers point generally towards the interior space of the trashcan. Further, in at least one embodiment in which the ends of the fingers point generally towards the interior space of the trashcan, the fingers define a central opening of the liner retention member.

In a fifth feature of this first aspect, a portion of a trashcan liner extends from the interior of the trashcan container over a rim of the trashcan container and through the liner engaging member and is disposed in frictional engagement with the fingers such that the trashcan liner is secured from slipping into the trashcan container when trash is received within the trashcan liner in the trashcan container.

In at least one embodiment of this fifth feature, only a portion of the trashcan liner extends through the liner engaging member in order to prevent the trashcan liner from slipping into the trashcan container.

In a second aspect of the invention, a method of making a trashcan assembly includes the steps of (a) providing a container having a peripheral wall defining an interior space for receipt of a trash bag therein; (b) providing an insert having a bag retention member comprising a plurality of resilient, flexible fingers configured to receive and retain a portion of a trash bag that is extended therethrough; (c) forming an opening in the peripheral wall of the container; and (d) securing an insert within the opening to the peripheral wall.

In a first feature of this second aspect, step (d) includes seating the insert in the opening, wherein a portion of the sidewall of the container is received within a channel of the insert.

In at least one embodiment of this first feature, said channel fully encircles a circumferential periphery of the insert.

In at least one embodiment of this first feature, and possibly concurrent with other enumerated embodiments, the insert is secured to the peripheral wall via a snap-fit mounting.

In at least one embodiment of this first feature, and possibly concurrent with other enumerated embodiments, the insert includes a flange that serves as a skirt to cover the periphery of the opening formed in the container.

In a second feature of this second aspect, each finger comprises a bent finger with the end thereof pointing toward the interior space of the container.

In a third aspect of the invention, a method of retrofitting a trashcan container having a peripheral wall defining an interior space for receipt of a trash bag therein includes the steps of forming an opening in the peripheral wall of the container; and securing an insert within the opening to the peripheral wall, the insert having a bag retention member comprising a plurality of resilient, flexible fingers configured to receive and retain a portion of a trash bag that is extended therethrough.

In a first feature of this third aspect, step (a) comprises cutting an opening in the peripheral wall.

In a second feature of this third aspect, step (a) comprises punching an opening in the peripheral wall.

In a fourth aspect of the invention, a trashcan assembly includes a trashcan container and an attachment member that is received on the rim of the trashcan container and that includes bag engaging members.

In a first feature of this fourth aspect, the attachment member resembles a band. In at least one embodiment of this first feature, the attachment member has an inner diameter of about fourteen inches. In at least one embodiment, possibly concurrent with the previous embodiment, the attachment member includes an annular recess within which the rim of the trashcan is received. The rim may be received in a snap-fit connection with the attachment member, or may be adhered or otherwise bonded to the attachment member for permanent attachment therebetween.

In a second feature of this fourth aspect, the attachment member may be injection molded from one or more materials. In at least one embodiment of this second feature, the materials include one or more thermoplastic materials and one or more elastomers. In at least one embodiment of this second feature, the attachment member is entirely made from the same material in an injection molding process, and each bag engaging member is formed by simply forming openings in the attachment member, either during the injection molding process or thereafter. In at least one other embodiment of this feature, the attachment member is formed from two portions that are co-molded together.

In a fifth aspect of the invention, a trashcan assembly includes a trashcan container and an interior container that is removably received within the container and that includes bag engaging members.

In a feature of this aspect, each bag engaging member comprises a panel that includes the plurality of the fingers of the trash bag retention member. In accordance with this feature, the panel is bonded directly to the peripheral wall of the interior container. Alternatively, the panel is bonded directly to a frame and the frame is attached to the peripheral wall of the interior container. The frame may be generally U-shaped and may be attached to the peripheral wall via a press-fit or snap-fit connection. Additionally or alternatively, the frame may be adhered to the peripheral wall of the interior container.

In still further accordance with this feature, an upper edge of the panel and the peripheral wall of the interior container together define a rim of the interior container.

Additional aspects of the invention include a trashcan assembly comprising a trashcan container and an insert having a liner retention member as shown and/or disclosed herein; a method of making a trashcan assembly as shown and/or disclosed herein; and a trashcan assembly as shown and/or disclosed herein.

Still yet, in another aspect of the invention, a trashcan assembly comprises a container having a bottom wall and a peripheral wall extending upwardly from the bottom wall, a rim of the peripheral wall defining an opening extending into the container, and a bag retention member located in an area of the peripheral wall with the bag retention member being generally coplanar with the peripheral wall in the area and being configured for receiving a portion of a trash bag for securing the trash bag to an outer surface of the peripheral wall. A trash bag may be extended over the rim and secured to the peripheral wall with the bag retention member.

In another aspect of the invention, a trashcan assembly comprises a container having a bottom wall and a peripheral wall extending upwardly from the bottom wall, a rim of the peripheral wall defining an opening extending into the container, a bag retention member located on the peripheral wall, and a trash bag received within the container and extending over the rim and secured to the peripheral wall with the bag retention member with a portion of the trash bag extending therethrough into an interior of the trashcan assembly.

In a feature of this aspect, the trashcan assembly further comprises a trash bag, wherein a portion of the trash bag extends through an aperture of the bag retention member into an interior of the trashcan assembly.

In another feature of this aspect, the trashcan assembly further comprises a plurality of bag retention members. In accordance with this feature, the plurality of bag retention members includes two bag retention members disposed in opposite facing relation with one another and, preferably, two pairs of such bag retention members, with each pair having a bag retention member disposed on opposite walls.

In still yet another feature, the arrangement of slits includes a circular aperture centrally located relative to the slits, each slit extending in a generally radial direction relative to the circular aperture.

In another aspect of the invention, a trashcan comprises a trash bag that has a top end that defines a mouth and a body having a surrounding wall and a top edge that defines a mouth. An opening is provided on the body adjacent the top edge wherein a portion of the trash bag is inserted through the opening of the body.

In a feature of this aspect, the body further includes fingers extending into the opening, with the fingers separated by spaces or slots. In still yet another feature of this aspect, the portion of the trash bag is adjacent the top end of the trash bag.

In an additional aspect of this invention, a method of securing a trash bag to the mouth of a trashcan comprises providing a trashcan having a body, having a surrounding wall, and having a top edge that defines a mouth with an opening provided on the body adjacent the top edge; positioning a trash bag so as to line the trashcan; and inserting a portion of the trash bag through the opening in order to secure the trash bag in lining disposition relative to the trashcan.

In a feature of this aspect, the step of inserting the portion of the trash bag through the opening comprises inserting the portion of the trash bag from an exterior of the trashcan, through the opening, into the interior of the trashcan.

In yet another aspect of the invention, a trashcan includes: a container having a base and a peripheral wall extending upwardly from the base forming an interior space for receipt of a trash bag therein; and a trash bag retention member disposed on the peripheral wall. The retention member defines a passageway into the interior space of the container and comprises a plurality of resilient, flexible fingers configured to receive and retain therebetween a portion of a trash bag. Each finger includes a portion thereof that extends away from the peripheral wall. In essence, each finger is “bent” and extends away from the peripheral wall. Thus, a finger may extend away from the peripheral wall on the exterior of the container, away from the peripheral wall on the interior of the container, or both. In this latter respect, a finger preferably includes both a portion that extends away from the peripheral wall on the exterior of the container and a portion that extends toward the interior space of the container.

In a feature of this aspect, the portion of a finger that extends toward the interior space of the container extends beyond the peripheral wall within the interior space of the container.

In a feature of this aspect, the retention member is disposed on the peripheral wall at a distance below a rim of the container, the peripheral wall completely surrounding the retention member.

In a feature of this aspect, the fingers of the retention member define a rounded indentation for receipt therein of the fingertip of a person's finger. The rounded indentation collectively may be defined by a lip of a bend or knuckle in each finger of the retention member.

In a feature of this aspect, the plurality of fingers consists of at least four fingers. Furthermore, the four fingers may define therebetween an open space in the shape of an “X,” wherein the ends of the open space are rounded or pear shaped. Additionally, each end of the open space in the shape of an “X” may comprise an opening that is approximately the size of the central opening centrally located between all of the terminal ends of the fingers.

In a feature of this aspect, each finger includes a curved portion. In a feature of this aspect, each finger includes two curved portions.

In a feature of this aspect, the fingers of the trash bag retention member are arranged about an aperture or central opening. The opening preferably comprises a generally oval or circular opening and may include dimensions sufficient to receive therein a person's finger without displacement of the fingers of the bag retention member. Alternatively, the circular opening may include dimensions insufficient to receive therein a person's finger without displacement of the fingers of the bag retention member.

In a feature of this aspect, the trashcan further includes a pliable trash bag received within the container, a top of the trash bag extending over a rim of the container and being received within and retained by the retention member.

In a feature of this aspect, the trashcan further includes a plurality of retention members disposed in the peripheral wall. The plurality of retention members may be only two retention members, each disposed in a respective, opposed sidewall of the container. Furthermore, the two retention members may be disposed in mirror relation to one another about a plane of symmetry of the trashcan.

In another aspect of the invention, a method of manufacturing a trashcan includes the steps of: forming a container having a base and a peripheral wall extending upwardly from the base, the peripheral wall and the base defining an interior space of the container for receiving a trash bag, wherein an aperture is formed in the peripheral wall; and attaching a trash bag retention member arranged to grasp and retain a portion of a trash bag when inserted therethrough, the trash bag retention member including an arrangement of flexible, resilient fingers, wherein the trash bag retention member is received within the aperture and affixed to the container.

In another feature of this aspect, the step of attaching the trash bag retention member to the container includes snapping the trash bag retention member into place within the aperture.

In a feature of this aspect, the aperture is formed adjacent a rim of the container.

In a feature of this aspect, the step of forming the container comprises molding the container. The molding may comprise injection molding. Moreover, making the bag retention member may include co-molding a frame and a flexible, resilient panel to the frame so as to define the insert. In this scenario, the frame preferably is formed from a first material and the panel is formed from a second, different material. The step of forming the container also may comprise injection molding the container, and the container may be formed from a third material different from the first and second materials or may be formed from the second material from which the frame is formed.

In at least one embodiment of any one of the preceding aspects, the container comprises a porcelain coated steel member.

In addition to the aforementioned aspects and features of the present invention, it should be noted that aspects of the present invention further encompasses the various possible combinations of such aspects and features. The invention also encompasses methods of using and methods of making the aforementioned container assemblies in accordance with such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is a perspective view of three different trashcan assemblies all generally in accordance with a first aspect of the present invention;

FIG. 2 is an exploded view of the three trashcan assemblies of FIG. 1;

FIG. 3 is a perspective view of another trashcan assembly in accordance with an alternative embodiment of the first aspect;

FIG. 4 is a front perspective view of an insert comprising a bag retention member in accordance with a second aspect of the present invention;

FIG. 5 is a rear perspective view of the insert of FIG. 4;

FIG. 6 is a side elevational view of the insert of FIG. 4;

FIG. 7 is a perspective view of a trashcan container having an opening for receipt therein of the insert of FIG. 4;

FIG. 8 is a perspective view of the combination of the trashcan container of FIG. 7 and the insert of FIG. 4;

FIG. 9 is a side elevational view, in partial cross-section, of the trashcan and insert of FIG. 8; and

FIG. 10 is a rear perspective view of the insert of FIG. 4 illustrating resilient fingers of the bag retention member bending in response to a finger moving in the direction of the arrow shown therein.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

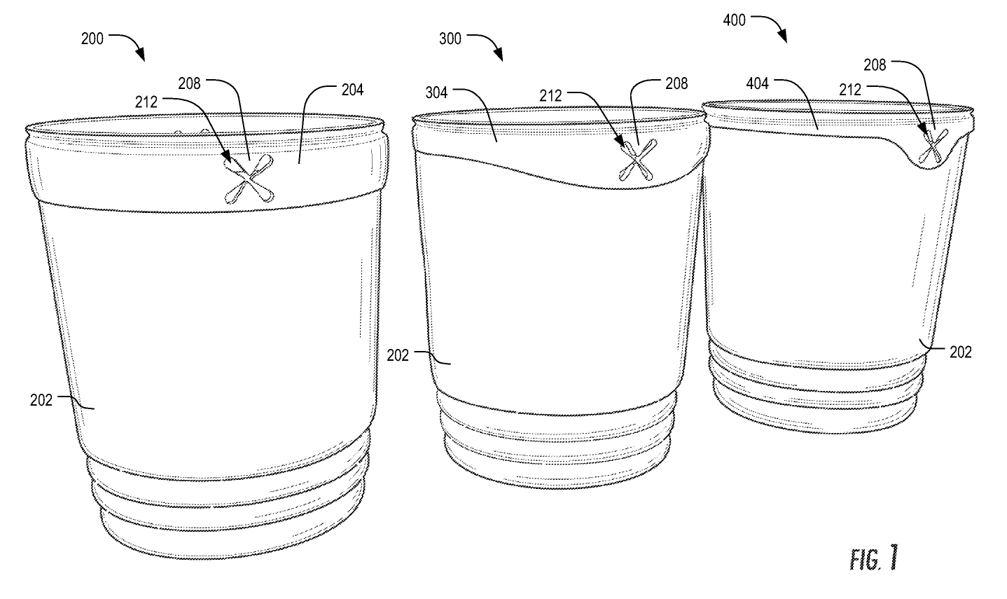

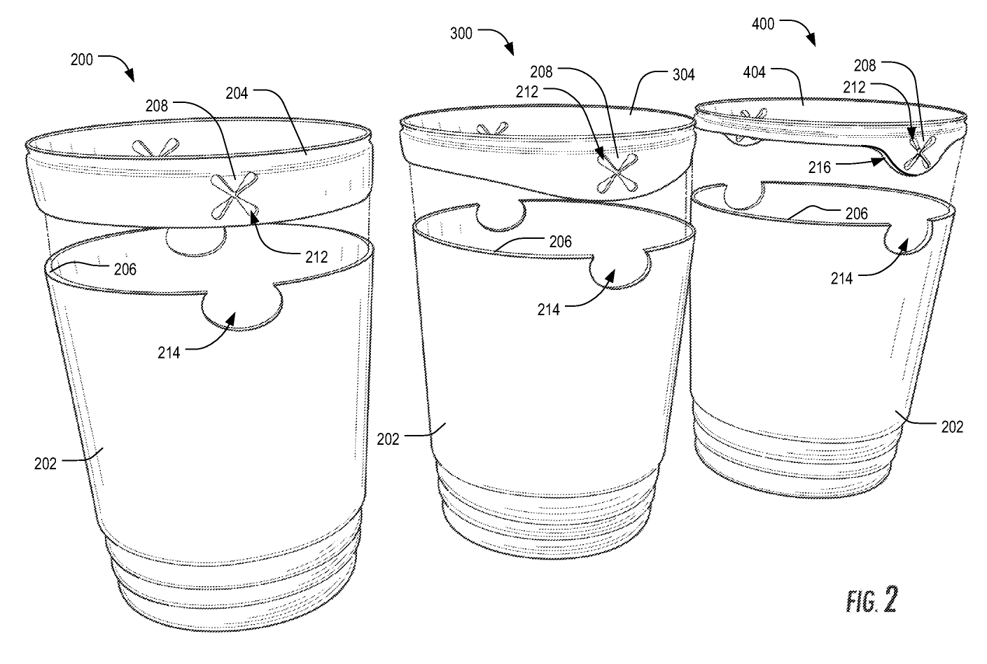

Turning now to FIGS. 1-2, three different trashcan assemblies 200,300,400 are illustrated, which are all generally in accordance with a first aspect of the present invention.

The trashcan assemblies 200,300,400 have many features in common. For example, each trashcan assembly includes a trashcan container 202 and an attachment member 204,304,404 that is received on a rim 206 of the trashcan container 202 and that includes at least one bag engaging member 208. The attachment member 204,304,404 generally resembles a band and has an inner diameter of about fourteen inches. The attachment member 204,304,404 also includes an annular recess (visible, for example, within the attachment member 404 on the right in FIG. 2) within which the rim 206 of the trashcan container 202 is received. The rim 206 may be received in a “press-fit” or “snap-fit” connection within the attachment member 204,304,404, or may be adhered or otherwise bonded to the attachment member 204,304,404 for permanent attachment thereto.

The trashcan assemblies 200,300,400 also have differentiating features. These features relate to the circumferential side profiles of the attachment member 204,304,404 in each assembly. In this respect, the first illustrated trashcan assembly 200 includes an attachment member 204 having a generally uniform height; the second illustrated trashcan assembly 300 includes an attachment member 304 having a height that gradually varies along the circumference of the trashcan container 202; and the third illustrated trashcan assembly 400 includes an attachment member 404 having a height that sharply increases in the areas of the bag engaging members 208.

For each of the assemblies, the attachment member 204,304,404 preferably is injection molded from one or more materials. The materials preferably comprise one or more thermoplastic materials and/or one or more elastomers.

In some embodiments, the entirety of the attachment member is made from the same material, i.e., a single source material, in an injection molding process, and each bag engaging member 208 is formed by simply forming openings 212 in the attachment member, either during the injection molding process or thereafter. In other embodiments, different portions of the attachment member 204,304,404 are formed from different source materials that are co-molded together, i.e., the bag engaging members 208 are preferably formed from a material that is more resilient and/or more flexible than the material from which the remainder of the attachment member 204,304,404 is formed.

As shown herein, the openings 212 have a generally X-shaped configuration. However, it will be understood that in at least some embodiments each opening 212 may have any configuration that enables a bag engaging member 208 to grasp and retain a trash bag when a portion thereof is inserted through the bag engaging member 208.

The bag engaging members 208 of any of the three trashcan assemblies 200,300,400 may include any one of the different types of bag engaging members that are disclosed in the incorporated references, including U.S. patent application Ser. Nos. 11/424,920; 11/424,942; 11/424,968; and 11/424,969.

The containers 202 of each of the three trashcan assemblies 200,300,400 are identical. It is preferred that the container 202 comprise a porcelain coated steel member. However, the container 202 may comprise a different material such as plastic or any other material conventionally used for forming trashcan containers. As will be apparent from the exploded view of FIG. 2, “cutouts” 214 are provided about the rim 206 of the container 202 so that each bag engaging member 208 provides access through the openings 212 therein into the interior of the container 202. Each cutout 214 generally corresponds to the area of the opening 212 of a bag engaging member 208.

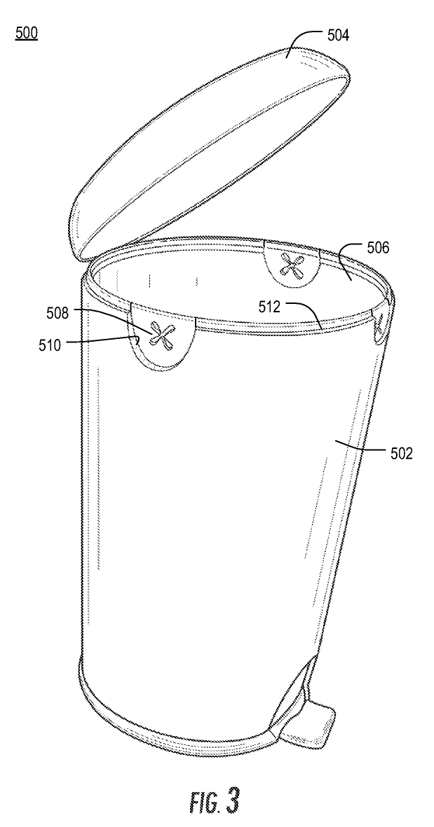

A trashcan assembly 500 in accordance with an embodiment of another aspect of the invention is illustrated in FIG. 3. The trashcan assembly 500 of FIG. 3 includes an outer container 502 having a hinged lid 504 as well as an interior container 506 that is removably received within the outer container 502. The outer container 502 preferably comprises a porcelain outer shell. However, the container 502 may comprise a different material such as plastic or any other material conventionally used for forming trashcan containers.

The interior container 506 includes bag engaging members 508 that register with “cutouts” 510 in the rim 512 of the container 502 when the interior container 506 is received therein, as shown in FIG. 3. Similar to the rim attachment member 204,304,404 of FIGS. 1-2, the interior container 506—including the bag engaging members 508—may be made in an injection molding process entirely from the same material, or the interior container 506—including the bag engaging members 508—may be made in an injection molding process in which portions are co-molded together, wherein the bag engaging members 508 are made from a material that is more resilient and/or more flexible than the material from which the remainder of the interior container 506 is made.

The bag engaging members 508 of the interior container 506 may include any of the different types of bag engaging members that are disclosed in U.S. patent application Ser. Nos. 11/424,920; 11/424,942; 11/424,968; and 11/424,969.

In a variation of the foregoing trashcan assemblies 200,300,400,500, the “cutouts” 214,510 in the rim 206,512 of the trashcan containers 202,502 of FIGS. 1-3 may be replaced with openings that do not extend to the top of the containers. In this variation, the top edge of the containers 202,502 thus may be continuous within a plane.

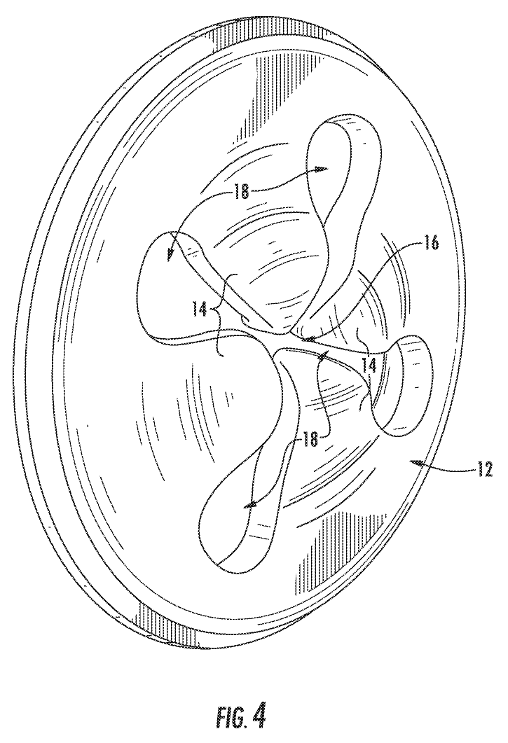

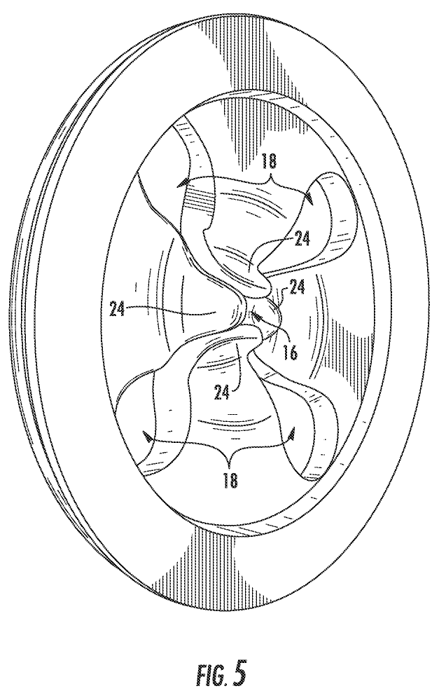

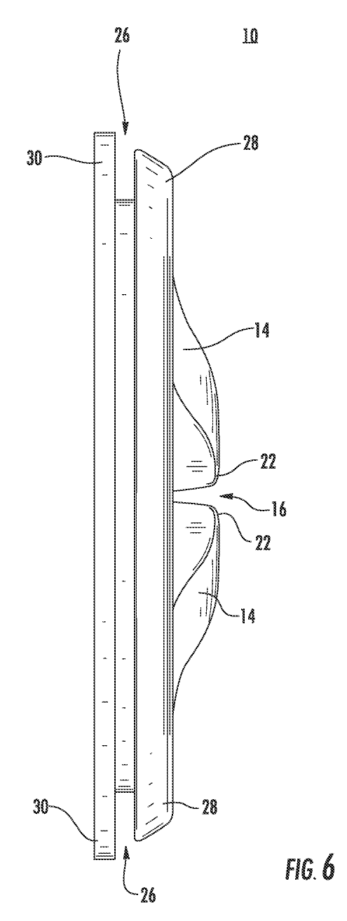

Now turning to a second aspect of the present invention and with reference to FIGS. 4-6 and 10, an insert 10 in accordance with a second aspect of the present invention is illustrated. In this regard, FIG. 4 illustrates a front perspective view of the insert 10; FIG. 5 illustrates a rear perspective view of the insert 10; and FIG. 6 illustrates a side elevational view of the insert 10.

As perhaps best seen in FIG. 6, the insert 10 includes a channel 26 that is formed in, and extends about, the periphery of the insert 10. The insert further includes a front skirt portion 28 and a rear skirt portion 30. As illustrated, the periphery of the insert 10 is generally circular, the channel 26 extends continuously about the insert 10, and the skirt portions 28,30 likewise are generally circular and extend continuously about the insert 10.

In accordance with the invention, the insert 10 includes a liner engaging member (sometimes alternatively referred to as a “liner engaging portion,” a “bag engaging member” or a “bag engaging portion”) indicated generally by 12. The liner engaging member 12 includes an arrangement of a plurality of fingers 14 that extend in a generally radial direction from a central opening or aperture 16. Together with the aperture 16, the fingers 14 define a passageway through the liner engaging member 12.

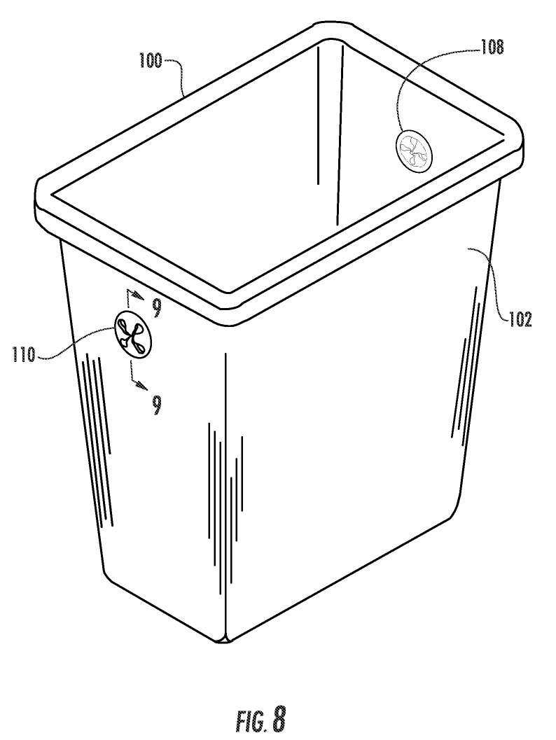

The fingers 14 further are configured to receive and retain a portion of a trash bag or liner when extended therethrough. Moreover, each finger 14 preferably is bent or curved such that the finger protracts (i.e., gently slopes) outwardly along a direction from a distal end thereof toward a proximal end thereof located at the aperture 16; and then retracts toward a rear of the liner engaging member 12 such that the terminal end or tip 24 of the finger 14 generally points toward the rear side of the liner engaging member 12 (i.e., toward the interior space of a trashcan when the liner engaging member is installed in a container as shown, for example, in FIG. 8 discussed below). The fingers 14 at their bends, i.e., at their “knuckles” 22, thereby serve to define and bound the central opening or aperture 16. As defined thereby, the aperture 16 may approximate the cross-sectional dimensions of an average human finger.

The fingers 14 themselves are defined by a plurality of slots 18 that also extend generally radially from the aperture 16. The proximal end of each slot 18 connects to the aperture 16, while each slot 18 includes a large rounded opening at its distal end that serves a venting function for release of air that otherwise may become trapped between a trashcan container 100 and a liner when the liner is first placed within the trashcan for use.

Additionally, the slots 18 as illustrated define an open space in the general shape of an “X,” wherein the ends of the open space are rounded or pear shaped. Additionally, each end of the open space in the shape of an “X” may comprise an opening that is approximately the size of the central opening 16 centrally located between all of the terminal ends of the fingers 14.

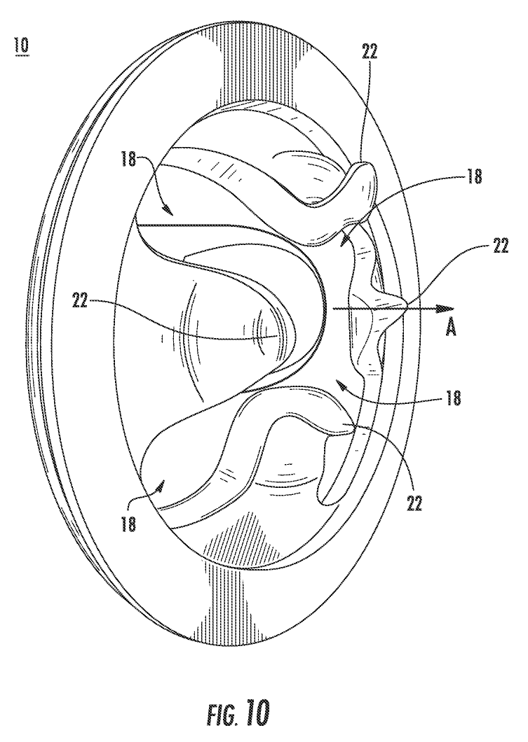

Each finger 14, of which there are four in the illustrated liner engaging member 12, preferably is resilient and flexible and returns to the position shown in FIG. 4 after being deflected or bent, such as may occur when a portion of a liner is inserted through the passageway. The insert fingers 14 are shown in FIG. 10 in deflected positions as the result of a human finger being inserted through the passageway in the direction of arrow A generally along the axis of the central opening 16. When the human finger is withdrawn, the insert fingers 14 return to the default positions as shown in FIGS. 4-6.

In a variation of the liner engaging member 12, not shown, the central opening 16 includes dimensions sufficient to receive therein a person's finger without displacement of the insert fingers 14. In such variation, the fingers 14 provide sufficient friction with a liner inserted through the passageway so as to keep the liner from slipping into a container during use. Sufficient friction is provided by both the coefficient of friction of the material used to form the fingers 14 and the surface area of the fingers 14 that is in contact with the liner. In this latter respect, the bending of the fingers 14 and their rearward extension (which would be toward the interior space of a container) increases the surface area of the fingers 14 that is in contact with the liner compared to fingers lacking such bend and rearward extension.

In another variation of the liner engaging member 12, not shown, the slots 18 (but not the central aperture 16) are replaced by areas of reduced thickness sections or walls and are formed from an elastic material such that the fingers 14 are movable and bendable relative to one another. In such alternative, these elastic areas are more easily stretched and deformed than the fingers 14. These elastic areas further may include openings that serve the venting function of the slots 18 of the liner engaging member 12.

In still other variations, the actual arrangement of the fingers 14 and the three dimensional contours thereof (i.e., the gradual sloping and then bending, etc.) may vary within the scope of the present aspect. Moreover, in some embodiments, the fingers of the liner engaging member may be generally coplanar with the insert and aligned with a section of a peripheral wall of a container and, thus, not include portions thereof protracting to any substantial extent beyond the bounds of the planes of the skirt portions of the insert. In such variations, the fingers would not protract outside of the planes of the skirt portions but, nevertheless, could still include bending with finger tips pointed rearward. Moreover, for example, the fingers could be “L” shaped, “J” shaped, or “T” shaped while still existing within the bounds of the planes of the skirt portions of the insert. In accordance with certain additional embodiments of this aspect of the invention, any one of the different arrangements of fingers may be used as disclosed, for example, in the incorporated references, including U.S. patent application Ser. Nos. 11/424,920; 11/424,942; 11/424,968; 11/424,969; 60/891,931; 11/778,839; and 11/778,841; U.S. Pat. No. 7,243,811; and U. S. Patent Application Publication No. 2007/0034334 A1.

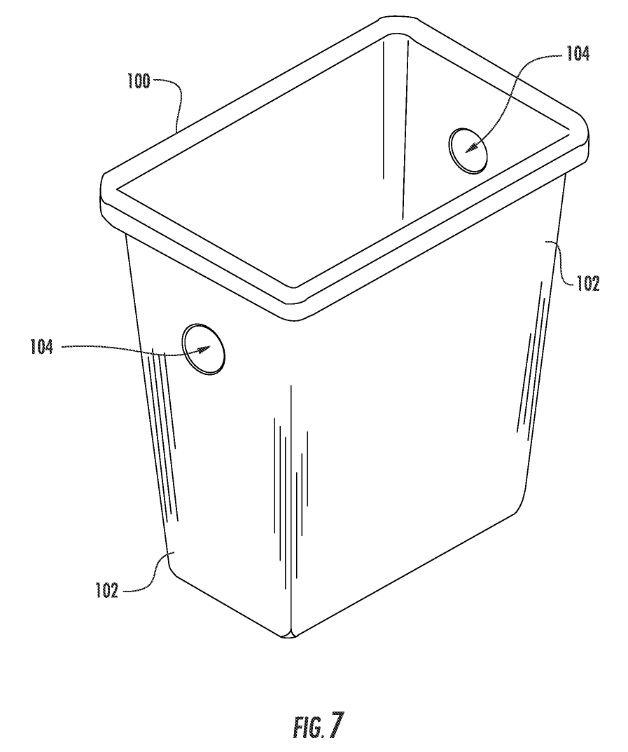

With particular reference now to FIGS. 7-9, installation of inserts 108,110 in a trashcan container 100—and the resulting trashcan assembly formed thereby—are described in detail. The inserts may be installed during manufacture of the container or during retrofitting of a conventional trashcan container.

In this respect, a trashcan container 100 is illustrated in FIG. 7. As shown therein, two openings 104 have been cut, punched, stamped, or otherwise formed in the wall 102 that forms the sides of the container 100. The openings 104 are illustrated as generally circular, but the invention is not limited to circular openings and, as will be apparent to the Ordinary Artisan, any other profile may be utilized as desired. The trashcan container 100 also may include a different arrangement and number of openings other than the two opposed openings 104 illustrated in FIGS. 7-9, as desired.

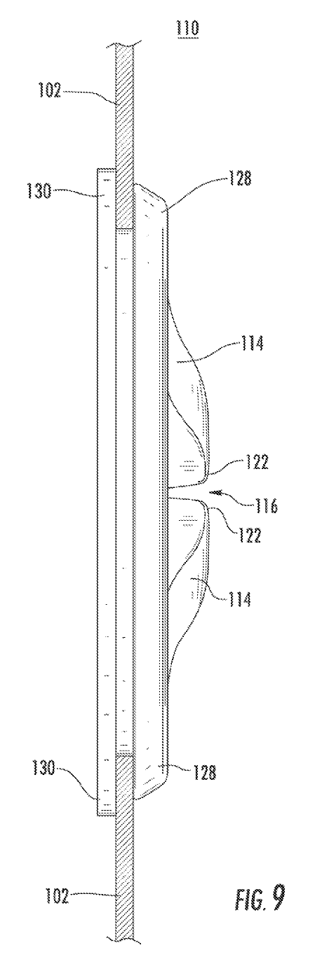

The inserts 108,110 are identical to one another, and each has a similar circular profile as each of the openings 104. Additionally, each insert 108,100 is substantially the same as the insert 10 of FIGS. 4-6 and 10 and, as such, a detailed description of each insert 108,110 is not included herein other than to acknowledge with reference to FIG. 9 that each insert 108,110 includes resilient bent fingers 114 having knuckles 122; a central opening or aperture 116 bounded by the knuckles 122; a front skirt 128; and a rear skirt 130.

Each insert 108,110 is installed in the wall 102 of the container 100 by forcing the insert 108,110 into a respective opening 104 such that the section of the wall 102 defining the respective opening 104 is received within the channel of the respective insert. Such disposition of inserts 108,110 is illustrated in FIG. 8. An insert 108,110 may be forced into an opening 104 in a direction from outside to inside of the container 100 but, preferably, such insert is forced into the opening 104 in a direction from inside to outside of the container. Such forcible seating causes deformation of at least a portion the insert but, due to the resilient nature of the insert, the insert quickly recovers upon its seating within the opening 104. Additionally, when properly seated in the opening 104, the front skirt 128 bounds the opening on the exterior surface of the wall 102 of the container 100, and the rear skirt 130 bounds the opening on the interior surface of the wall 102 of the container 100. When installed in the container 100, each insert 108,110 defines a passageway into the interior space of the trashcan container for receipt therethrough and retention therein of a portion of a trashcan liner.

In variations of the container 100, not shown, the container may have a round shaped periphery or an elliptical shaped periphery rather than a generally rectangular shaped periphery like container 100. An insert 108,110 may be placed into an opening of a container of any shape in the same way as described for container 100. In a further variation of this aspect of the invention, the shape of the insert may mimic the shape of the container. For example, for an elliptically shaped container, the insert may also be elliptically shaped.

The insert may be manufactured from a resilient, rubber-like or plastic material and may constitute a single piece. The insert also may be received within the opening of the peripheral wall in a “press-fit” or “snap-fit” connection and, optionally, may be adhered or otherwise bonded for permanent attachment to the wall.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-96. (canceled)

97. A method of making an assembly comprising the steps of:
(a) forming a container having a top rim defining a mouth of the container and a side opening into an interior of the container from an exterior of the container;
(b) forming an attachment member; and
(c) attaching the attachment member to the rim of the container such that the attachment member extends around the rim of the container;
(d) wherein the attachment member includes a bag engaging member located in covering relation to the side opening.

98. The method of claim 97, wherein the step of forming an attachment member comprises forming the attachment member such that the attachment member defines a recess within which the rim of the container is received whereby the attachment member attaches to the container.

99. The method of claim 97, wherein the step of forming an attachment member comprises forming the attachment member such that the attachment member resembles a band.

100. The method of claim 97, wherein the step of forming an attachment member comprises forming the attachment member such that the attachment member may be received on top of the rim of the container.

101. The method of claim 97, wherein the step of forming a container comprises forming the container such that the container defines a plurality of side openings into an interior of the container from an exterior of the container, and the step of forming an attachment member comprises forming the attachment member such that the attachment member includes a plurality of bag engaging members, each bag engaging member respectively covering one of the side openings.

102. A method of using an assembly comprising the steps of:
(a) providing an assembly comprising a container having a top rim defining a mouth of the container and an attachment member that is attached to and extends around the rim of the container, wherein the container further defines a side opening into an interior of the container from an exterior of the container, and wherein the attachment member includes a bag engaging member located in covering relation to the side opening;
(b) disposing a pliable liner within the container and extending the liner over the rim of the container; and
(c) retaining the pliable liner with the bag engaging member.

103. An assembly comprising a container having a top rim defining a mouth of the container and an attachment member that is attached to and extends around the rim of the container, wherein the container defines a side opening into an interior of the container from an exterior of the container, and wherein the attachment member includes a bag engaging member located in covering relation to the side opening.

104. The assembly of claim 103, wherein the bag engaging member is configured to receive and retain a pliable liner in a covering disposition within the interior of the container.

105. The assembly of claim 103, wherein the attachment member defines a recess within which the rim of the container is received whereby the attachment member attaches to the container

106. The assembly of claim 103, wherein a pliable liner is disposed within the container and extends over the rim and is retained by engagement with the bag engaging member.

107. The assembly of claim 103, wherein the attachment member resembles a band.

108. The assembly of claim 103, wherein the attachment member is received on top of the rim of the container.

109. The assembly of claim 103, wherein the container defines a plurality of side openings into an interior of the container from an exterior of the container, and wherein the attachment member includes a plurality of bag engaging members, each bag engaging member respectively covering one of the side openings.

110. The assembly of claim 103, wherein the side opening is only partially bounded by a peripheral wall of the container.

111. The assembly of claim 103, wherein the side opening is completely bounded by a peripheral wall of the container.

112. The assembly of claim 103, wherein the container is a trashcan container.

113. The assembly of claim 103, wherein the bag engaging member defines an open space in the shape of an “X”.
